(19) United States
(12) Patent Application Publication
(10) Pub. No.: US 2019/0291358 A1
(43) Pub. Date: Sep. 26, 2019

(54) Method For Producing Three-Dimensional Object, Ink Set, And Apparatus For Producing Three-Dimensional Object

(71) Applicant: Seiko Epson Corporation, Tokyo (JP)

(72) Inventors: Chigusa SATO, Shiojiri (JP); Masashi KUWABARA, Matsumoto (JP)

(21) Appl. No.: 16/361,307

(22) Filed: Mar. 22, 2019

(30) Foreign Application Priority Data
Mar. 23, 2018 (JP) 2018-057016

(51) Int. Cl. B29C 67/00; B29C 64/112; B29C 64/264

(52) U.S. Cl. CPC B29C 67/0007; B29C 64/264; B29C 64/112

(57) ABSTRACT

A method is provided for producing a three-dimensional object by stacking cured layers of a photocurable color ink composition containing a coloring material. The method includes applying the photocurable color ink composition onto an underlying member; and curing the photocurable color ink composition with light. The content of the coloring material in the photocurable color ink composition is in the range of 0.25% by mass to 2.1% by mass.

This application claims priority under 35 U.S.C. § 119 to Japanese Patent Application No. 2018-057016 filed on Mar. 23, 2018, the entire disclosure of which is expressly incorporated by reference herein.

### BACKGROUND

### 1. Technical Field

The present invention relates to a method for producing a three-dimensional object, an ink set, and an apparatus operable to produce a three-dimensional object.

### 2. Related Art

There is known a method for producing a desired three-dimensional object by stacking cured thin layers formed by curing a photocurable ink composition on the basis of data of a three-dimensional shape. A known method for curing a photocurable ink composition includes ejecting fine droplets of a photocurable ink composition through nozzles by an ink jet method so as to form a predetermined pattern in an image drawing manner, and curing the ejected photocurable ink composition by irradiation of, for example, UV radiation, and a series of these operations is repeated to yield a three-dimensional object. For such a method, it has been studied to adjust the tone of the three-dimensional object.

For example, JP-A-2016-215576 discloses a method in which the thickness of the cured layers is controlled to adjust the tone of the three-dimensional object. In this method, a pale color is expressed by reducing the thickness of cured layers to about 10 μm, and a deep color is expressed by increasing the thickness of cured layers.

Unfortunately, reducing the thickness of cured layers to express a pale color makes the resulting three-dimensional object grainy. In the method disclosed in JP-A-2016-215576, the color tone of the three-dimensional object recognized when observed is controlled so as to be deeper than the tone of each layer of a plurality of layers constituting the three-dimensional object. However, this document does not describe any measure to suppress the graininess that occurs when a pale color is expressed.

### SUMMARY

An advantage of some aspects of the invention is that it provides a method and an apparatus for producing a three-dimensional object and an ink set used in the method that enable graininess to be reduced when a pale color is expressed by controlling the thickness of cured layers and that enable a deep color to be satisfactorily developed when the deep color is expressed by controlling the number of cured layers to be stacked.

The present inventors conducted intensive research to solve the above issues and found that the issues can be resolved by a method for producing a three-dimensional object by stacking cured layers, the method using a photocurable color ink composition containing a coloring material with a content in a specific range to form the cured layers.

(1) According to an aspect of the invention, there is provided a method for producing a three-dimensional object by stacking cured layers of a photocurable color ink composition containing a coloring material. The method includes applying the photocurable color ink composition onto an underlying member, and curing the photocurable color ink composition with light. The content of the coloring material in the photocurable color ink composition is in the range of 0.25% by mass to 2.1% by mass.

(2) According to another aspect of the invention, there is provided a method for producing a three-dimensional object by stacking cured layers formed of a photocurable color ink composition containing a coloring material and a photocurable clear ink composition containing no coloring material. The method includes applying the photocurable color ink composition and the photocurable clear ink composition onto an underlying member, and curing the photocurable ink compositions with light. The content of the coloring material in the photocurable color ink composition is in the range of 0.25% by mass to 2.1% by mass.

(3) The cured layers each may have a thickness in the range of 4 μm to 15 μm.

(4) A 10 μm-thick photo-cured film formed by curing the photocurable color ink composition with light may have an optical density in the range of 0.30 to 1.00.

(5) A 100 μm-thick photo-cured film formed by curing the photocurable color ink composition with light may have an optical density in the range of 1.80 to 2.30.

(6) In the above-described method, the applying of the photocurable color ink composition or the photocurable color ink composition and the photocurable clear ink composition may include: obtaining formative data set for each cured layer of the three-dimensional object; generating ink ejection data for each cured layer by using the corresponding formative data set, the ink ejection data being used for ejecting the photocurable color ink composition for the corresponding cured layer; and ejecting the photocurable color ink composition layer by layer. The ink ejection data are generated by dithering for a halftoning operation of the formative data set, and when the halftoning operation is executed for each of the cured layers to be stacked, a dither mask is applied in different manners to the same position of the cured layers to which the photocurable color ink composition is deposited.

(7) An ink set used in a method for producing a three-dimensional object is also provided. The ink set includes a photocurable color ink composition containing a coloring material, and a photocurable clear ink composition containing no coloring material. The content of the coloring material in the photocurable color ink composition is in the range of 0.25% by mass to 2.1% by mass.

(8) Furthermore, there is provided an apparatus adapted to produce a three-dimensional object by stacking cured layers of a photocurable color ink composition containing a coloring material. The content of the coloring material in the photocurable color ink composition is in the range of 0.25% by mass to 2.1% by mass.

### BRIEF DESCRIPTION OF THE DRAWINGS

The invention will be described with reference to the accompanying drawings, wherein like numbers reference like elements.

FIG. 1 is a flow chart of the method for producing a three-dimensional object according to an embodiment of the invention.

FIG. 2 is a functional block diagram illustrating the structure of a three-dimensional object producing system.

FIG. 3 is a flow chart of ink ejection data generation executed by a CPU of a host computer.

FIG. 4 is an illustrative representation of the relationship between a three-dimensional object and dots.

FIG. 5 is an illustrative schematic representation of formative data sets for each of the cured layer of a three-dimensional object.

FIG. 6 is an illustrative representation of the correspondence between a dither mask and a formative data set.

FIG. 7 is an illustrative representation of a halftoning operation using a dither mask having the same threshold array for each of the three-dimensional object layers.

FIG. 8 is an illustrative representation of a halftoning operation using different threshold arrays of a dither mask for the cured layers to be stacked on each other.

### DESCRIPTION OF EXEMPLARY EMBODIMENTS

Some embodiments of the invention will now be described in detail with reference to the drawings as needed. However, the invention is not limited to the disclosed embodiments, and various modifications may be made without departing from the scope and spirit of the invention. The same elements in the drawings are designated by the same reference numerals, and thus description thereof is omitted. The relative positions and other positional relationship are in accordance with the drawings unless otherwise specified. The dimensional proportions in the drawings are not limited to those shown in the drawings. In the description of the present disclosure, (meth)acrylate refers to an acrylate and the corresponding methacrylate.

### Three-Dimensional Object Producing Method

In a method for producing a three-dimensional object according to an aspect of the present disclosure, cured layers of a photocurable color ink composition containing a coloring material are stacked to produce a three-dimensional object. The cured layers are each formed by applying the photocurable color ink composition onto an underlying member, and curing the photocurable color ink composition with light. The content of the coloring material in the photocurable color ink composition is in the range of 0.25% by mass to 2.1% by mass.

In a method for producing a three-dimensional object according to another aspect of the present disclosure, cured layers of a photocurable color ink composition containing a coloring material and a photocurable clear ink composition containing no coloring material are stacked to form a three-dimensional object. The cured layers are formed by applying the photocurable color ink composition and the photocurable clear ink composition onto an underlying member, and curing the photocurable ink compositions with light. The content of the coloring material in the photocurable color ink composition is in the range of 0.25% by mass to 2.1% by mass.

In the following description, the former and the latter method are collectively referred to as the three-dimensional object producing method.

In the three-dimensional object producing method disclosed herein, the photocurable color ink composition used for forming the cured layers contains 0.25% by mass or more of a coloring material. The use of such a photocurable color ink composition enables a deep color to be satisfactorily developed when the deep color is expressed by controlling the number of cured layers to be stacked. Also, the coloring material content in the photocurable color ink composition is 2.1% by mass or less. The use of such a photocurable color ink composition enables graininess to be reduced when a pale color is expressed by controlling the thickness of cured layers.

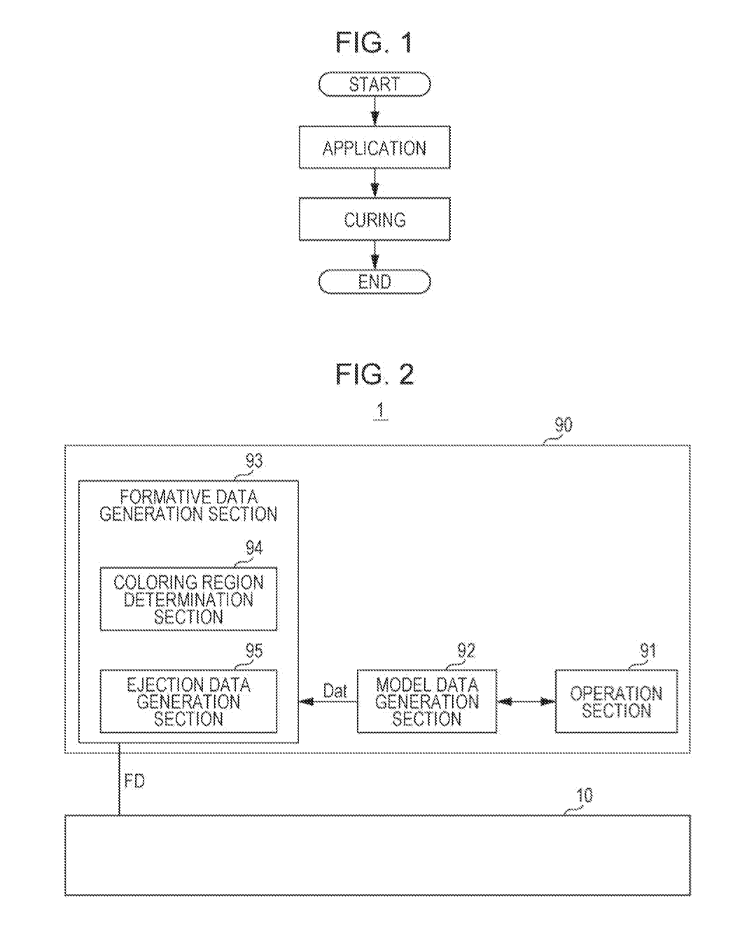

FIG. 1 is a flow chart of the method for producing a three-dimensional object according to an embodiment of the invention. As shown in FIG. 1, the three-dimensional object producing method of the present embodiment may include, for example, applying a photocurable color ink composition or a photocurable color ink composition and a photocurable clear ink composition onto an underlying member by ejecting the ink composition(s) by an ink jet method, and curing the photocurable ink compositions to form a cured layer by irradiating the underlying member with ultraviolet light. Although the flow chart shown in FIG. 1 depicts a process for forming a three-dimensional object consisting of a single cured layer, the steps of application and curing may be repeated to from a three-dimensional object including a plurality of cured layers.

### Application

In the application step, a photocurable color ink composition or a photocurable color ink composition and a photocurable clear ink composition are ejected onto an underlying member by an ink jet method, thus being applied onto the underlying member. In the case of applying both a photocurable color ink composition and a photocurable clear ink composition onto an underlying member, the photocurable clear ink composition may be applied onto the region not subjected to the application of the photocurable color ink composition to uniformize the height of the cured layer.

### Photocurable Color Ink Composition

The photocurable color ink composition contains a coloring material and may optionally contain a polymerizable compound, a photopolymerization initiator, a sensitizer, a surfactant, a polymerization inhibitor, and a dispersant.

The coloring material may be a dye or a pigment. In some embodiments, a pigment may be used from the viewpoint of reliably producing the intended effects.

If a dye is used, the dye may be, but is not limited to, an acid dye, a direct dye, a reactive dye, or a basic dye. Examples of such a dye include C.I. Acid Yellows 17, 23, 42, 44, 79, and 142, C.I. Acid Reds 52, 80, 82, 249, 254, and 289, C.I. Acid Blues 9, 45, and 249, C.I. Acid Blacks 1, 2, 24, and 94, C.I. Food Blacks 1 and 2, C.I. Direct Yellows 1, 12, 24, 33, 50, 55, 58, 86, 132, 142, 144, and 173, C.I. Direct Reds 1, 4, 9, 80, 81, 225, and 227, C.I. Direct Blues 1, 2, 15, 71, 86, 87, 98, 165, 199, and 202, C.I. Direct Blacks 19, 38, 51, 71, 154, 168, 171, and 195, C.I. Reactive Reds 14, 32, 55, 79, and 249, and C.I. Reactive Blacks 3, 4, and 35. These dyes may be used individually or in combination.

If a pigment is used, the pigment may be an inorganic pigment or an organic pigment. Examples of the inorganic pigment include, but are not limited to, carbon blacks such as furnace black, lamp black, acetylene black, and channel black, iron oxide, and titanium oxide. Examples of the organic pigment include azo pigments, such as insoluble azo pigments, condensed azo pigments, azo lake, and chelate azo pigments; polycyclic pigments, such as phthalocyanine pigments, perylene and perinone pigments, anthraquinone pigments, quinacridone pigments, dioxane pigments, thioindigo pigments, isoindolinone pigments, and quinophthalone pigments; and dye chelates, dye lakes, nitro pigments, nitroso pigments, aniline black, and daylight fluorescent pigments. These pigments may be used individually or in combination.

Carbon blacks include: No. 2300, No. 900, MCF 88, No. 33, No. 40, No. 45, No. 52, MA7, MA8, MA100, and No. 2200B (each produced by Mitsubishi Chemical Corporation); Raven 5750, Raven 5250, Raven 5000, Raven 3500, Raven 1255, and Raven 700 (each produced by Carbon Columbia); Regal 400R, Regal 330R, Regal 660R, Mogul L, Monarch 700, Monarch 800, Monarch 880, Monarch 900, Monarch 1000, Monarch 1100, Monarch 1300, and Monarch 1400 (each produced by Cabot); and Color Black FW1, Color Black FW2, Color Black FW2V, Color Black FW18, Color Black FW200, Color Black 5150, Color Black S160, Color Black S170, Printex 35, Printex U, Printex V, Printex 140U, Special Black 6, Special Black 5, Special Black 4A, and Special Black 4 (each produced by Degussa).

A white pigment, such as C.I. Pigment Whites 6, 18, or 21, may also be used.

Yellow pigments that may be used as the coloring material include C.I. Pigment Yellows 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 155, 167, 172, and 180.

Magenta pigments that may be used as the coloring material include C.I. Pigment Reds 1, 2, 3, 4, 5, 6, 7, 8, 9, 10, 11, 12, 14, 15, 16, 17, 18, 19, 21, 22, 23, 30, 31, 32, 37, 38, 40, 41, 42, 48(Ca), 48(Mn), 57(Ca), 57:1, 88, 112, 114, 122, 123, 144, 146, 149, 150, 166, 168, 170, 171, 175, 176, 177, 178, 179, 184, 185, 187, 202, 209, 219, 224, and 245; and C.I. Pigment Violets 19, 23, 32, 33, 36, 38, 43, and 50.

Cyan pigments that may be used as the coloring material include C.I. Pigment Blues 1, 2, 3, 15, 15:1, 15:2, 15:3, 15:34, 15:4, 16, 18, 22, 25, 60, 65, and 66; and C.I. Vat Blues 4 and 60.

Pigments other than magenta, yellow, cyan, and yellow pigments may be used, and examples thereof include C.I. Pigment Greens 7 and 10, C.I. Pigment Browns 3, 5, 25, and 26, and C.I. Pigment Oranges 1, 2, 5, 7, 13, 14, 15, 16, 24, 34, 36, 38, 40, 43, and 63.

The content of the coloring material in the photocurable color ink composition is in the range of 0.25% by mass to 2.1% by mass. When the coloring material content is 0.25% by mass or more, a deep color expressed by controlling the number of cured layers to be stacked is satisfactorily developed. Also, the use of the photocurable color ink composition containing 2.1% by mass or less of coloring material enables graininess to be reduced when a pale color is expressed by controlling the number of cured layers to be stacked. In addition, when the coloring material content is 2.1% by mass or less, the irradiation energy required to cure the photocurable color ink composition can be low, and, thus, the ink composition is superior in UV curability. In some embodiments, the coloring material content may be 0.30% by mass or more or 0.40% by mass or more and may be 2.0% by mass or less or 1.9% by mass or less, from the same viewpoint.

The polymerizable compound may be, but is not limited to, a photopolymerizable compound that is polymerized and solidified when irradiated with UV radiation or the like. The photopolymerizable compound may be a monofunctional monomer, a bifunctional monomer, or a trifunctional or higher functional monomer.

Examples of the monofunctional monomer include isoamyl (meth)acrylate, stearyl (meth)acrylate, lauryl (meth)acrylate, octyl (meth)acrylate, decyl (meth)acrylate, isomyristyl (meth)acrylate, isostearyl (meth)acrylate, 2-ethylhexyl-diglycol (meth) acrylate, 2-hydroxybutyl (meth)acrylate, 4-hydroxybutyl (meth)acrylate, butoxyethyl (meth) acrylate, ethoxydiethylene glycol (meth) acrylate, methoxydiethylene glycol (meth)acrylate, methoxypolyethylene glycol (meth)acrylate, methoxypropylene glycol (meth) acrylate, phenoxyethyl (meth) acrylate, tetrahydrofurfuryl (meth) acrylate, isobornyl (meth) acrylate, 2-hydroxyethyl (meth) acrylate, 2-hydroxypropyl (meth)acrylate, 2-hydroxy-3-phenoxypropyl (meth)acrylate, flexible lactone-modified (meth) acrylate, t-butylcyclohexyl (meth) acrylate, dicyclopentanyl (meth) acrylate, dicyclopentenyloxyethyl (meth) acrylate, and isobornyl (meth) acrylate.

Examples of the bifunctional (meth)acrylates include dipropylene glycol di(meth)acrylate, di propylene glycol di(meth)acrylate, 2-(2-vinyloxyethoxy)ethyl acrylate, triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonane diol di(meth)acrylate, neopentyl glycol di(meth)acrylate, dimethylol tricyclodecane di(meth)acrylate, bisphenol A ethylene oxide adduct di(meth)acrylate, bisphenol A propylene oxide adduct di(meth)acrylate, hydroxypivalic acid neopentyl glycol di(meth)acrylate, and polytetramethylene glycol di(meth)acrylate.

Examples of the trifunctional or higher functional monomer include trimethylolpropane tri(meth)acrylate, EO-modified trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glycerinpropoxy tri(meth)acrylate, caprolactone-modified trimethylolpropane tri(meth)acrylate, pentaerythritolethoxy tetra(meth)acrylate, and caprolactam-modified dipentaerythritol hexa(meth)acrylate.

Polymerizable compounds may be used individually or in combination.

The polymerizable compound content in the photocurable color ink composition may be in the range of 80% by mass to 97% by mass. In some embodiments, it may be in the range of 85% by mass to 95% by mass from the viewpoint of reliably producing the intended effects.

Examples of the photopolymerization initiator include aromatic ketones, acylphosphine compounds, aromatic onium salt compounds, organic peroxides, thio compounds, hexaaryl biimidazole compounds, ketoxime ester compounds, borate compounds, azinium compounds, metallocene compounds, active ester compounds, compounds having a carbon-halogen bond, and alkylamine compounds. In some embodiments, an acylphosphine compound may be used as the photopolymerization initiator from the viewpoint of reliably producing the intended effects.

The photopolymerization initiator is commercially available, and examples thereof include IRGACURE 651 (2,2-dimethoxy-1,2-diphenylethane-1-one), IRGACURE 184 (1-hydroxycyclohexylphenyl ketone), DAROCUR 1173 (2-hydroxy-2-methyl-1-phenyl-propane-1-one), IRGACURE 2959 (1-[4-(2-hydroxyethoxy)phenyl]-2-hydroxy-2-methyl-1-propane-1-one), IRGACURE 127 (2-hydroxy-1-{4-[4-(2-hydroxy-2-methyl-propionyl)-benzyl]phenyl}-2-methyl-propane-1-one), IRGACURE 907 (2-methyl-1-(4-methylthiophenyl)-2-morpholinopropane-1-one), IRGACURE 369 (2-benzyl-2-dimethylamino-1-(4-morpholinophenyl)-butanone-1), IRGACURE 379 (2-(dimethylamino)-2-[(4-methylphenyl)methyl]-1-[4-(4-morpholinyl)phenyl]-1-butanone), DAROCUR TPO (2,4,6-trimethylbenzoyl-diphenyl-phosphine oxide), IRGACURE 819 (bis(2,4,6-trimethylbenzoyl)-phenylphosphine oxide), IRGACURE 784 (bis(η5-2,4-cyclopentadiene-1-yl)-bis(2,6-difluoro-3-(1H-pyrrole-1-yl)-phenyl) titanium), IRGACURE OXE (1,2-octanedione, 1-[4-(phenylthio)-, 2-(O-benzoyloxime)]), IRGACURE OXE 02 (ethanone, 1-[9-ethyl-6-(2-methylbenzoyl)-9H-carbazole-3-yl]-, 1-(0-acetyloxime)), and IRGACURE 754 (mixture of oxyphenyl acetic acid, 2-[2-oxo-2-phenylacetoxyethoxy]ethyl ester and 2-(2-hydroxyethoxy)ethyl ester) (each produced by BASF); KAYACURE DETX-S (2,4-diethylthioxanthone) (produced by Nippon Kayaku Co., Ltd.); Lucirin TPO, LR8893 and LR8970 (each produced by BASF); Speedcure TPO and Speedcure DETX (each produced by Lambson); and Ubecryl P36 (produced by UCB). These photopolymerization initiators may be used individually or in combination.

The photopolymerization initiator content in the photocurable color ink composition may be in the range of 1% by mass to 20% by mass. In some embodiments, it may be in the range of 5% by mass to 15% by mass from the viewpoint of reliably producing the intended effects.

Examples of the polymerization inhibitor include, but are not limited to, hydroquinone compounds, such as hydroquinone, hydroquinone monomethyl ether (MEHQ), 1-o-2,3,5-trimethylhydroquinone, and 2-tert-butylhydroquinone; catechol compounds, such as catechol, 4-methylcatechol, and 4-tert-butylcatechol; phenol compounds, such as phenol, butylhydroxytoluene, butylhydroxyanisole, p-methoxyphenol, cresol, pyrogallol, 3,5-di-t-butyl-4-hydroxytoluene, 2,2′-methylenebis(4-methyl-6-t-butylphenol), 2,2′-methylenebis(4-ethyl-6-butylphenol), and 4,4′-thio(3-methyl-6-t-butylphenol); and hindered amines, such as 4-hydroxy-2,2,6,6-tetramethylpiperidinyl-1-oxyl and other compounds having a 2,2,6,6-tetramethylpiperidine-N-oxyl skeleton, compounds having a 2,2,6,6-tetramethylpiperidine skeleton, compounds having a 2,2,6,6-tetramethylpiperidine-N-alkyl skeleton, and compounds having a 2,2,6,6-tetramethylpiperidine-N-acyl skeleton. These polymerization inhibitors may be used individually or in combination.

The polymerization inhibitor content in the photocurable color ink composition may be in the range of 0.1% by mass to 1.0% by mass.

The surfactant may be, but is not limited to, an acetylene glycol-based surfactant, a fluorosurfactant, or a silicone surfactant. In some embodiments, a silicone surfactant may be used from the viewpoint of reliably producing the intended effects.

The silicone surfactant may be, but is not limited to, BYK-3500, UV3570, or BYK350 (each produced by BYK).

The surfactant content in the photocurable color ink composition may be in the range of 0.1% by mass to 1.0% by mass.

Examples of the dispersant include, but is not limited to, polyoxyalkylene polyalkylene polyamines, vinyl polymers and copolymers, acrylic polymers and copolymers, polymers, silicon-containing polymers, sulfur-containing polymers, fluorine-containing polymers, and epoxy resins. The dispersant may contain mainly one or more of these polymers. The dispersant is commercially available, and examples thereof include AJISPER series produced by Ajinomoto Fine-Techno, Solsperse series, such as Solsperse 36000, available from Avecia Co., DISPER BYK series, such as DISPER BYK 168 and DISPER BYK 180, produced by BYK, and DISPARLON series produced by Kusumoto Chemicals. These dispersant may be used individually or in combination.

The dispersant content in the photocurable color ink composition may be in the range of 0.1% by mass to 1.0% by mass.

A 10 μm-thick photo-cured film formed by curing the photocurable color ink composition may have an optical density (OD) in the range of 0.30 to 1.00. When such a photo-cured film has an OD value in this range, color development of expressed deep colors tends to be enhanced. From the same viewpoint, the OD value of the 10 μm-thick photo-cured film of the photocurable color ink composition may be 0.35 or more or 0.40 or more and may be 0.95 or less or 0.93 or less. The OD value of the 10 μm-thick photo-cured film may be determined by the method used in the Examples that will be described later herein.

In the three-dimensional object producing method disclosed herein, deep colors expressed by controlling the number of cured layers to be stacked are satisfactorily developed. Thus, a 100 μm-thick photo-cured film formed by curing the photocurable color ink composition may have an optical density (OD) in the range of 1.80 to 2.30. In some embodiments, the OD value of the 100 μm-thick photo-cured film may be 1.81 or more or 1.82 or more.

### Photocurable Clear Ink Composition

The photocurable clear ink composition used in the three-dimensional object producing method disclosed herein will now be described. The photocurable clear ink composition contains no coloring material and may optionally contain a polymerizable compound, a photopolymerization initiator, a sensitizer, a surfactant, a polymerization inhibitor, and a dispersant.

The polymerizable compound is not particularly limited and may be selected from the polymerizable compounds cited above for the photocurable color ink composition. The polymerizable compound content in the photocurable clear ink composition may be in the range of 80% by mass to 97% by mass. In some embodiments, it may be in the range of 85% by mass to 95% by mass from the viewpoint of reliably producing the intended effects.

The photopolymerization initiator is not particularly limited and may be selected from the photopolymerization initiators cited above for the photocurable color ink composition. The photopolymerization initiator content in the photocurable clear ink composition may be in the range of 1% by mass to 20% by mass. In some embodiments, it may be in the range of 5% by mass to 15% by mass from the viewpoint of reliably producing the intended effects.

The polymerization inhibitor is not particularly limited and may be selected from the polymerization inhibitors cited above for the photocurable color ink composition. The polymerization inhibitor content in the photocurable clear ink composition may be in the range of 0.1% by mass to 1.0% by mass.

The surfactant is not particularly limited and may be selected from the surfactants cited above for the photocurable color ink composition. The surfactant content in the photocurable clear ink composition may be in the range of 0.1% by mass to 1.0% by mass.

The dispersant is not particularly limited and may be selected from the dispersants cited above for the photocurable color ink composition. The dispersant content in the photocurable clear ink composition may be in the range of 0.1% by mass to 1.0% by mass.

### Ink Jet Method

A piezoelectric ink jet method may be applied. Although the three-dimensional object producing method disclosed herein is not necessarily performed by an ink jet method, ink jet methods helps form highly precise three-dimensional objects.

### Underlying Member

The underlying member for the first layer is the base on which a three-dimensional object is to be formed and is not otherwise limited. The underlying member may be in the form of a layer, such as a light shield layer that can block light. In the description of the present disclosure, the underlying member for the second or higher order layer refers to the cured layer immediately under the second or higher order layer.

### Curing

In the step of curing after the application of the photocurable color ink composition or the photocurable color ink composition and the photocurable clear ink composition, the underlying member is irradiated with light to cure the photocurable ink compositions, thus forming a cured layer.

The light decomposes the photopolymerization initiator to produce a species that can initiate photopolymerization, such as radicals, an acid, or a base. Examples of such light include a radiation, y radiation, X-ray radiation, UV radiation, visible radiation, and an electron beam. In some embodiment, UV radiation may be used. The light source of such light may be a mercury lamp, a metal halide lamp, a UV light emitting diode (UV-LED), or a UV laser diode (UV-LD).

### Cured Layer

Cured layers are formed by applying the photocurable color ink composition or the photocurable color ink composition and the photocurable clear ink composition onto the underlying member, and curing the photocurable ink compositions with light.

The thickness of the cured layers may be in the range of 4 μm to 15 μm from the viewpoint of reducing graininess that may occur when a pale color is expressed. In some embodiments, the thickness of the cured layers may be 5 μm or more or 8 pat or more and may be 13 μm or less or 12 μm or less, from the same viewpoint.

In the three-dimensional object producing method disclosed herein, the application of the photocurable color ink composition or the photocurable color ink composition and the photocurable clear ink composition may include obtaining formative data sets for each cured layer of the three-dimensional object; generating ink ejection data sets for each cured layer by using the corresponding formative data set; and ejecting the photocurable ink composition layer by layer. The ink ejection data sets are each generated by dithering for a halftoning operation of the corresponding formative data set, and when the halftoning operation is executed for each of the cured layers to be stacked, a dither mask is applied in different manners to the same position of the cured layers where the photocurable color ink composition is deposited. This method may also be referred to as dither mask shift control. The three-dimensional object producing method including these steps facilitates reduction of graininess that may occur when a pale color is express and the color development of deep colors.

### Obtaining Formative Data Sets

In the step of obtaining formative data sets, formative data sets for each cured layer of a three-dimensional object are obtained in, for example, a three-dimensional object producing system including a host computer and a three-dimensional object producing apparatus.

FIG. 2 is a functional block diagram illustrating the structure of a three-dimensional object producing system 1. The three-dimensional object producing system 1 includes a three-dimensional object producing apparatus 10 and a host computer 90 operable to generate data used for producing a three-dimensional object. The three-dimensional object producing apparatus 10 is operable to eject a photocurable ink composition and to cure the ejected ink composition. The host computer 90 executes formative data generation to generate formative data sets FD each determining the shape and color of the corresponding cured layer of the three-dimensional object to be produced by the three-dimensional object producing apparatus 10.

The host computer 90 shown in FIG. 2 includes: a CPU (not shown) operable to control the operation of each section of the host computer 90; a display section (not shown), such as a display device; an operation section 91, such as a keyboard or a mouse; information storage (not shown) operable to store application programs including a host computer 90 control program, a driver program of the three-dimensional object producing apparatus 10, and a CAD (computer aided design) software program; model data generation section 92 operable to generate model data Dat; and a formative data generation section 93 operable to generate formative data sets FD on the basis of the model data Dat.

The model data Dat mentioned herein refers to the data specifying the shape and coloration of a model to be produced by the three-dimensional object producing apparatus 10, that is, the data specifying the shape and the coloration of the three-dimensional object Obj to be produced. In the description given hereinafter, the coloration of a three-dimensional object includes how the colors are applied to the three-dimensional object Obj when the three-dimensional object will have a plurality of colors, that is, includes colorations of the pattern, the letters or characters and other figures represented by the colors applied to the three-dimensional object.

The model data generation section 92 is a functional block implemented by executing the application programs stored in the CPU of the host computer 90. The model data generation section 92, which may be implemented as, for example, a CAD application program, generates model data Dat that specify the shape and the coloration of the three-dimensional object on the basis of the information inputted through the operation section 91 by the use of the three-dimensional object producing system 100.

In the present embodiment, the model data Dat specify the external shape of the three-dimensional object and the coloration at the surface thereof. In other words, if the three-dimensional object is a hollow object, the model data Dat specify the outline of the hollow object. If the three-dimensional object is a spherical object, the model data Dat represent the shape of the spherical surface that is the outline of the spherical object. However, the method of the present disclosure is not limited to such implementation, provided that the model data Dat include at least information specifying the external shape of the three-dimensional object. For example, the model data Dat may include the internal shape and the material of the three-dimensional object, as well as the shape and the coloration of the three-dimensional object. The model data Dat may be, for example, in AMF (Additive Manufacturing File Format), STL (Standard Triangulated Language), or any other data format.

The formative data generation section 93 is a functional block implemented by executing the driver program of the three-dimensional object producing apparatus 10 stored in the information storage section of the CPU of the host computer 90. The formative data generation section 93 functions as a data obtaining section and generates formative data sets FD specifying the shape and the coloration of the object to be produced by the three-dimensional object producing apparatus 10 for each three-dimensional object layer on the basis of the model data Dat generated by the model data generation section 92. The formative data generation section 93 also functions as an ejection data generation section operable to generate ink ejection data sets for each three-dimensional object layer by using the corresponding formative data set FD. The formative data generation section 93 includes a coloring region determination section 94 and an ejection data generation section 95 so as to function as the data obtaining section and the ejection data generation section, thus executing data generation to generate formative data sets FD determining the shape and the coloration of the three-dimensional object to be produced by the three-dimensional object producing apparatus 10. Although in the disclosed embodiment, the host computer 90 includes the formative data generation section 93 operable to generate formative data sets FD, the three-dimensional object producing apparatus 10 may include the formative data generation section 93.

In the following embodiment, a three-dimensional object is produced by stacking a Q number of cured layers (wherein Q is a natural number satisfying Q 2). In the following description, an operation of the three-dimensional object producing apparatus 10 for forming an object is referred to as stacking. That is, the operation of the three-dimensional object producing apparatus 10 for producing a three-dimensional object includes a Q number of times of stacking.

For generating a Q number of formative data sets FD each determining the shape and coloration of the corresponding layer of the Q number of layers having a predetermined thickness, the formative data generation section 93, first, generates sectional model data sets corresponding 1:1 to the respective cured layers by slicing the three-dimensional shape represented by the model data Dat at a thickness of Lz for each layer. The sectional model data set is a set of data representing the shape and coloration of a sectional object produced by slicing the three-dimensional shape represented by the model dada Dat. In this instance, the sectional model data set includes data representing the shape and coloration of the section produced by slicing the three-dimensional shape represented by the model dada Dat. The thickness Lz corresponds to the height of a dot of the ink.

Next, the formative data generation section 93 determines the arrangement of dots to be formed by the three-dimensional object producing apparatus 10 for forming a cured layer corresponding to the shape and coloration represented by the sectional model data set and outputs the determined dot arrangement as a formative data set FD. A formative data set FD is a set of data specifying the type of ink for forming each of a plurality of dots representing the shape and coloration represented by a sectional model data set. The dots are defined by segmenting the shape and coloration represented by the sectional model data set in a grid manner. The formative data set FD may include data representing the size of the dot. The dot mentioned herein refers to a solidified small block of ink ejected by one ejection operation. In the present embodiment, the dot is dealt with as a rectangular solid or a cube that has a thickness Lz and a predetermined volume for convenience sake. In the present embodiment, the volume and other dimensions of the dot are determined by the pitch of nozzles through which ink is ejected, the intervals of ink ejection, the viscosity of the ink, or any other factors.

The coloring region determination section 94 determines the region where dots formed of coloring ink of all the dots formed by the three-dimensional object producing apparatus 10 are formed. The coloring region is a region to be colored by ejecting a coloring ink onto the surface of a shape defined by dots of a shape-forming ink, and the coloring region determination section 94 determines a coloring region such that the depth of the coloring region in the direction normal to the surface of the three-dimensional object does not vary much. For example, the depth of the coloring region from the surface may be set constant.

### Generating Ink Ejection Data

In the step of generating ink ejection data, ink ejection data are generated by using the obtained formative data set. This step may be executed in, for example, the ejection data generation section 95. The ejection data generation section 95 generates, for example, coloring ink ejection data that are a type of formative data used for ejecting the photocurable color ink composition or both the photocurable color ink composition and the photocurable clear ink composition.

The model data Dat of the present embodiment specify the external shape (outline) of the three-dimensional object Obj, as described above. Accordingly, if a three-dimensional object is formed as closely as possible to the shape represented by the model data Dat, the resulting three-dimensional object is a hollow object defined by only an outline with no thickness. However, for producing a three-dimensional object, it is beneficial to determine the internal shape of the three-dimensional object in view of the strength of the three-dimensional object. For example, a part or the entirety of the three-dimensional object may be solid. Accordingly, the formative data generation section 93 of the present embodiment generates formative data sets FD from which a partially or entirely solid three-dimensional object is produced, irrespective of whether or not the shape specified by the model data Dat is hollow.

Depending on the shape of the three-dimensional object, the m-th layer immediately under the n-th layer may not have any dots under the dots of the n-th layer. In such a case, when dots are formed in the n-th layer, some of the dots may fall down. Accordingly, a support adapted to support such dots is provided under the dots so that the dots defining a cured layer can be formed at appropriated positions. In the present embodiment, the support is formed by dots of a solidified ink as in the case of the three-dimensional object. Accordingly, the formative data set FD includes data used for forming dots forming the support required when a three-dimensional object is produced. Hence, in the present embodiment, a cured layer includes a portion to be formed in the q-th stacking operation as a part of the three-dimensional object and a support portion to be formed in the q-th stacking operation as a part of a support. In other words, the formative data FD set include data representing dots defining the shape and coloration of a portion of the three-dimensional object Obj and data representing dots defining the shape of a portion of the support. The formative data generation section 93, in the present embodiment, determines whether or not a support is required to form dots on the basis of the sectional model data or the model data Dat. If the determination result is positive (yes), the formative data generation section 93 generates a formative data set FD that allows a support to be formed in addition to the portion defining the three-dimensional object. In some embodiments, the support may be formed of a material, such as a water-soluble ink, that can be readily removed after the production of the three-dimensional object. The ink used for forming dots forming the support is hereinafter referred to as a support ink.

### Ejecting Photocurable Ink Composition

In this step, the photocurable color ink composition is ejected layer by layer. This step is the same as the application of the photocurable ink composition.

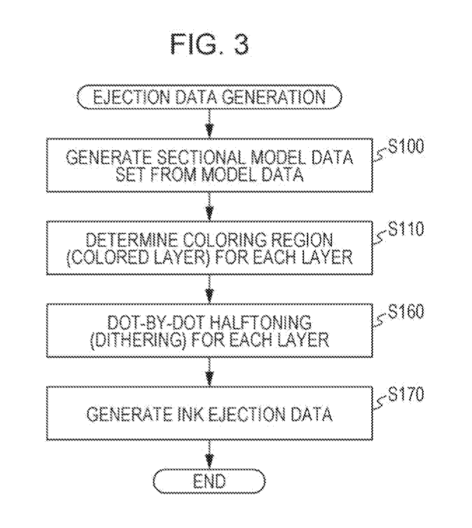

FIG. 3 is a flow chart of the operation of generating ink ejection data, executed by the CPU of the host computer 90. This operation is executed by the CPU acting as the formative data generation section 93 after the model data generation section 92 of the host computer 90 has generated model data Dat. On starting this operation, the formative data generation section 93 generates sectional model data sets from the model data Dat in Step S100. In Step S110 following step S100, the coloring region determination section 94 determines a coloring region. More specifically, it is determined which dots DT of the dots DT forming each layer will be formed of the coloring ink. The coloring region determination section 94 also determines a clear layer, a shield layer and a formative layer, which will be described later herein, as well as the coloring region.

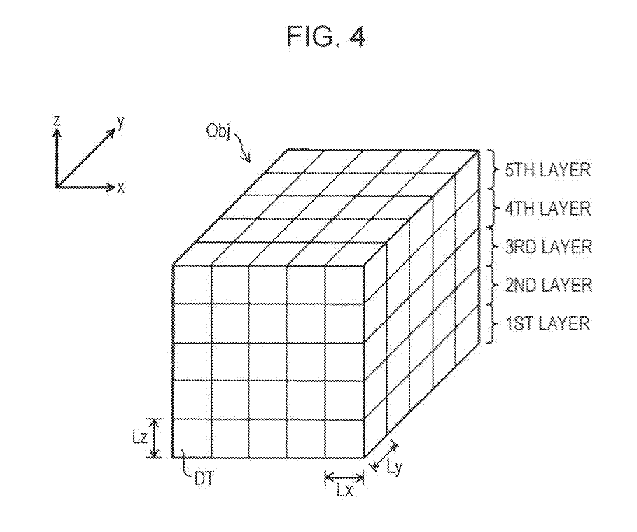

FIG. 4 is an illustrative representation of the relationship between a three-dimensional object and dots DT. For ease of description, FIG. 4 depicts a cubic object consisting of an n number of layers from the first layer to the n-th layer (n=5). In the formative data generation section 93, the shape of a three-dimensional object is defined by a set of dots DT each having a depth Ly, a width Lx, and a height Lz. Lx is a dimension of a dot DT in the x direction and is equivalent to the pitch of nozzles Nz. Ly is a dimension of a dot DT in the y direction and is equivalent to the moving distance of the printing head according to ink ejection interval. Lz is a dimension of a dot DT in the z direction. Lz depends on the viscosity and the amount of the ink to form the dot. The sectional model data set for a layer is defined as a set of dots DT two-dimensionally arranged in the x and the y direction and corresponds to the formative data set FD for a layer of the cured layers stacked in the z direction.

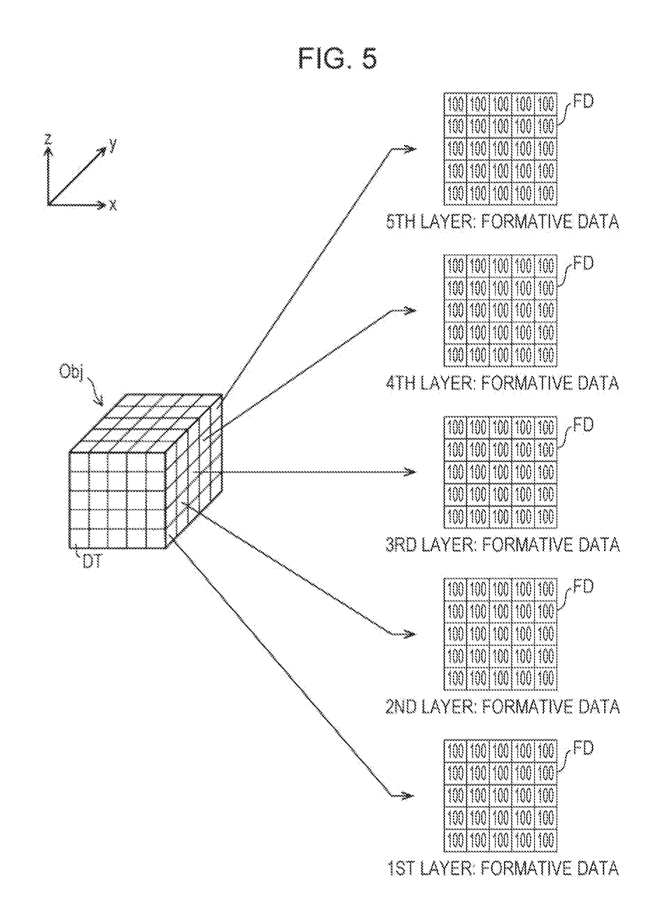

FIG. 5 is an illustrative schematic representation of formative data sets FD for each cured layer of a three-dimensional object.

Each formative data set FD for the first to fifth layers has a 5×5 data matrix structure, and data (tone value) for a dot include data specifying the coloration and properties, specifically coloring region, of the dot. For ease of description, the tone value of each dot in the formative data set FD for a layer is supposed to be 100. For determining the coloring region in Step S110, the coloring region determination section 94 determines the coloring region on the basis of the formative data set FD. Formative layers define the major shape of the resulting three-dimensional object. Each formative layer is provided with a shield layer on the surface thereof. The shield layer is operable to shield the formative layer and is formed of a photocurable white ink composition (a type of the photocurable color ink composition). Each shield layer is provided with a coloring layer on the surface thereof. The coloring layer is a coloring region to color the three-dimensional object. The coloring layer is formed of a photocurable color ink composition or the photocurable clear ink composition. If the tone value of the photocurable color ink composition is low, the photocurable color ink composition may not be ejected to a portion of the coloring region. Since the photocurable color ink composition is one of the inks that form a shape, a void may be left in the portion to which the photocurable color ink composition is not ejected. The photocurable white ink composition fills the portion that is not subjected to ejection of that photocurable color ink composition to reduce the formation of a void. As an alternative to the photocurable white ink composition, the photocurable clear ink composition may be used. The clear layer is operable to protect the coloring layer and may be or may not be formed.

After the determination of the coloring region, the CPU of the host computer 90 executes Step S160 and following step after the operation of Step S110 shown in FIG. 3. In the embodiment shown in FIG. 3, the ejection data generation section 95 executes dithering for dot-by-dot halftoning in Step S160 and then generates ink ejection data in Step S170.

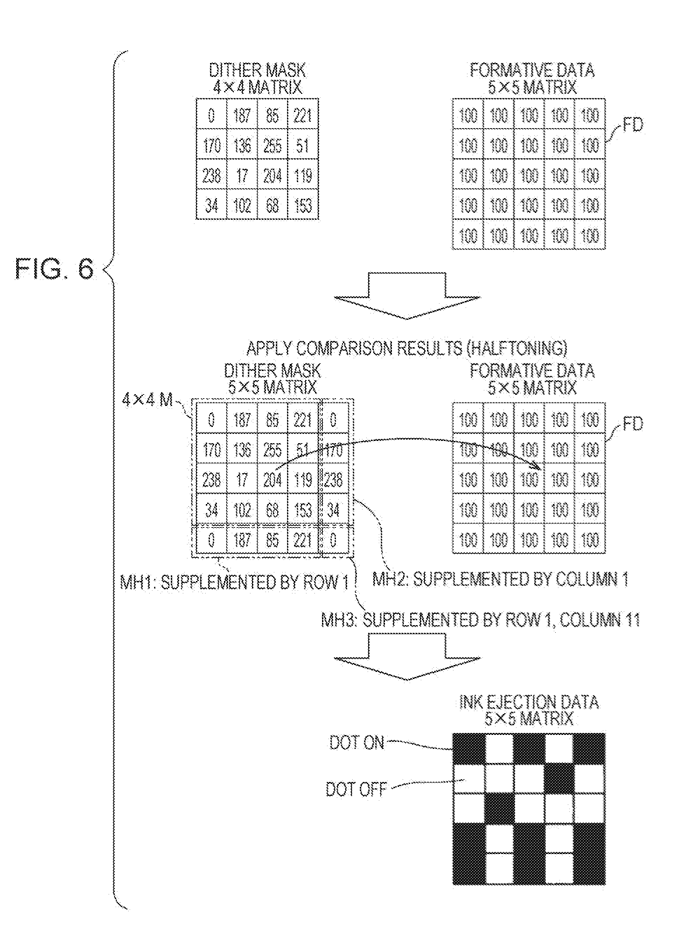

FIG. 6 is an illustrative representation of the correspondence between a dither mask and a formative data set FD. As shown in FIG. 6, the dither mask has a 4×4 matrix structure, while the formative data set FD has a 5×5 matrix larger than the dither mask. However, these matrixes are used for easy description of the following halftoning operation. In an actual three-dimensional object producing apparatus 10, the dither mask may have a matrix structure with more rows and more columns, such as 64×64, 512×512, or 1024×1024, and the formative data sets FD of the cured layers corresponding to an actual three-dimensional object has a larger matrix structure than such a dither mask.

Since the dither mask has a smaller matrix structure than the formative data set FD, a 5×5 dither mask is generated by using the dither mask having a 4×4 matrix structure. More specifically, as shown in FIG. 6, a first supplementary region MH1, a second supplementary region MH2, and a third supplementary region MH3 are generated for regions lacking without being filled by the 4×4 matrix by using the 4×4 dither mask. The threshold values of the first row of the 4×4 dither mask are applied to the first supplementary region MH1; and the threshold values of the first column of the 4×4 dither mask are applied to the second supplementary region MH2. To the third supplementary region MH3, the threshold value at the first row and the first column of the 4×4 dither mask is applied. A 5×5 dither mask is thus generated, and the 5×5 dither mask is used for binarization in halftoning operation with comparison with the 5×5 formative data set FD. The halftoning operation determines to apply dot ON represented as black as shown at the bottom of FIG. 6 to the dots having a tone value larger than the threshold value in the 5×5 dither mask and to apply dot OFF represented as white to the dots having a tone value lower than or equal to the threshold value. Dot OFF implies that the photocurable white ink composition is ejected to the dot position to prevent a void from being formed in the resulting three-dimensional shape instead of ejecting a magenta, cyan or yellow ink that is a photocurable color ink composition and does not mean that no ink is ejected to the corresponding dot.

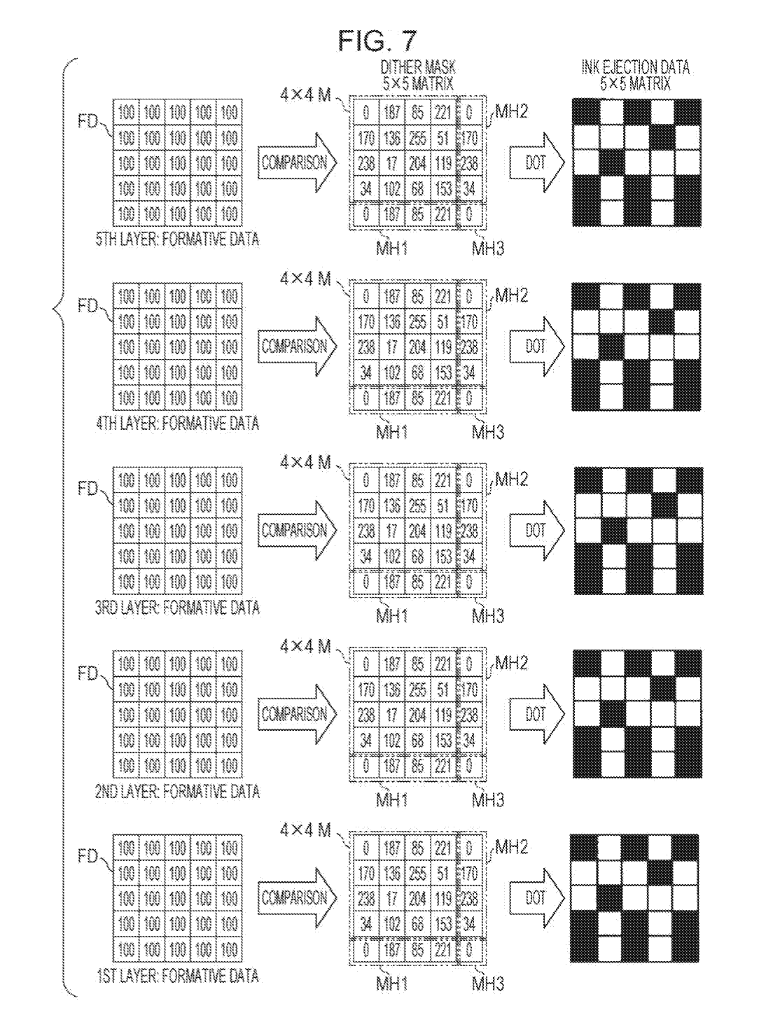

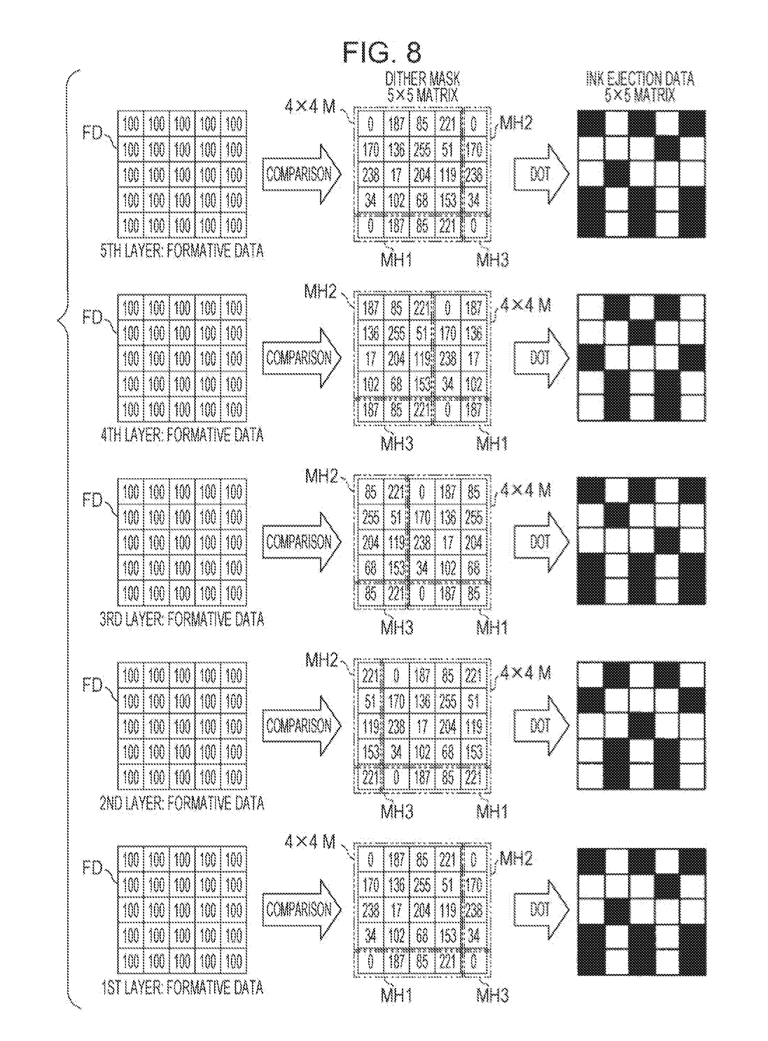

The halftoning operation using the 5×5 dither mask thus generated will now be described. FIG. 7 is an illustrative representation of a halftoning operation using the same dither mask having a threshold array for each of the three-dimensional object layers. FIG. 8 is an illustrative representation of a halftoning operation using different threshold arrays of a dither mask for the cured layers stacked on each other. In the halftoning operation shown in FIG. 8 employed by the three-dimensional object producing apparatus 10 of the present embodiment, the comparison is characteristic.

In the halftoning operation shown in FIG. 7, the same dither mask having a threshold array is applied to the formative data sets FD for the first to fifth layers. Accordingly, the same arrangement of dot ON represented as black in the figure and dot OFF represented as white in the figure is applied to each of the cured layers. Thus, the ink ejection data having the same dot ON, dot OFF arrangement are generated for each cured layer in Step S170. On the other hand, in the halftoning operations shown in FIG. 8 employed by the three-dimensional object producing apparatus 10 of the present embodiment, the 5×5 dither mask applied to the formative data set FD for the first layer shown at the bottom of FIG. 8 is shifted one dot column to the right for the second layer. More specifically, the 4×4 matrix of the 5×5 dither mask applied to the formative data set FD for the first layer is shifted one dot column to the right, and the first supplementary region MH1 to the third supplementary region MH3 are formed for the lacking region in the 5×5 matrix structure produced by the shift of the 4×4 matrix by using the 4×4 dither mask. This may be considered to be equivalent to shifting of a 5×5 dither mask in an imaginary dither mask in which a 4×4 dither mask is surrounded by the same dither masks. Thus, the first layer and the second layer stacked on each other are subjected to halftoning by dithering using a dither mask so as to have different threshold arrays for each layer. The same applies to the second and third layers, the third and fourth layers, and the fourth and fifth layers. Thus, in the halftoning operation for each of the cured layers stacked on each other, different threshold values are applied to the same position of the layers of the three-dimensional object to which ink is deposited for stacking. Thus, in the halftoning operation shown in FIG. 8, the dot ON (black), dot OFF (white) arrangement varies among the three-dimensional object layers stacked on each other. Thus, the ink ejection data having different dot ON, dot OFF arrangements are generated for the cured layers stacked on each other in Step S170. The ink ejection data thus generated include coloring ink ejection data for ejecting a photocurable color ink composition or both a photocurable color ink composition and the photocurable clear ink composition and other ink ejection data.

As described above, in the present embodiment, the host computer 90 executes halftoning for generating ink ejection data for each cured layer of the three-dimensional object by dithering, which is a simple operation in which the threshold values of the formative data set are simply compared with the threshold value in the dither mask. In addition, in the halftoning operation for the cured layers stacked on each other, different threshold arrays of a dither mask are used to apply different threshold values to the same position of the cured layers to which a photocurable color ink composition or both a photocurable color ink composition or the photocurable clear ink composition are deposited for stacking. The three-dimensional object producing apparatus 10 of the present embodiment thus avoids connecting dots of a chromatic photocurable color ink composition, deposited at the same position of each layer, at the surface of the three-dimensional object, thus reducing vertical streaks.

In the present embodiment, the halftoning of the host computer 90 applies different threshold values to the same position of the different cured layers stacked on each other by using a dither mask in such a manner as to shift the dither mask. Since the host computer 90 of the present embodiment does not require a plurality of dither masks having different threshold values, the memory capacity for the mask can be saved. Since a single dither mask is merely shifted, the calculation load of the host computer 90 is reduced or is not increased.

Although in the embodiment disclosed above, a single dither mask is shifted one dot column in a direction of the column arrangement, the dither mask may be shifted a different number of dot columns for the cured layers stacked on each other. For example, the matrix of the dither mask of the first layer may be shifted one dot column for the second layer, and the matrix of the second layer may be shifted two dot columns for the third layer. In an embodiment, the dither mask may be shifted an irregular number of dot columns. In an embodiment, the dither mask may be shifted one dot row or another number of dot rows in a direction of row arrangement. In an embodiment, the dither mask may be rotated 90 degrees or a predetermined angle or flipped relative to an axis parallel to the rows or columns.

Although in the embodiment disclosed above, different threshold values are applied to the same position of the cured layers of a photocurable color ink composition stacked on each other, dither masks having different threshold arrays may be used for the respective layers. This also allows the dither masks to be applied in different manners to the same position of the cured layers of a photocurable color ink composition stacked on each other.

### Three-Dimensional Object

The three-dimensional object mentioned herein is a stack of cured layers. The number of cured layers to be stacked on each other may be, but is not limited to, 1 to 30 or 5 to 15.

In the present disclosure, a 2.5-dimensional shape such as an embossed shape or a stereoscopic map is also a type of the three-dimensional object.

### Ink Set

An ink set may be used in the three-dimensional object producing method according to an embodiment of the present disclosure. The ink set includes a photocurable color ink composition containing a coloring material and a photocurable clear ink composition containing no coloring material. The coloring material content in the photocurable color ink composition is in the range of 0.25% by mass to 2.1% by mass.

The photocurable color ink composition and the photocurable clear ink composition described for the above-described three-dimensional object producing method may be used as the ink compositions of the ink set.

The three-dimensional object producing apparatus disclosed herein is used for producing a three-dimensional object by stacking cured layers of a photocurable color ink composition, and the photocurable color ink composition contains 0.25% by mass to 2.1% by mass of a coloring material.

The three-dimensional object producing apparatus of the present disclosure is not particularly limited provided that it is used in the above-described three-dimensional object producing method. For example, the three-dimensional object producing apparatus may include a stage on which an object is roughly formed, an ejection device capable of ejecting the photocurable color ink composition or the photocurable color ink composition and the photocurable clear ink composition onto the stage, a transport device operable to transport the ejection device to a plane parallel to the stage, and a radiation source operable to cure the ink compositions.

### EXAMPLES

The photocurable clear ink composition used in the Examples and Comparative Examples contains the following constituents.

### Polymerizable Compounds:

Phenoxyethyl acrylate
2-(2-Vinyloxyethoxy)ethyl acrylate Photopolymerization Initiator:
Irgacure 819 (acylphosphine oxide-based photoradical polymerization initiator, produced by BASF)
Speedcure TPO (acylphosphine oxide-based photoradical polymerization initiator, produced Lambson)

### Sensitizer:

Speedcure DETX (thioxanthone-based compound, produced by Lambson)

### Surfactant:

BYK-3500 (produced by BYK)

### Polymerization Inhibitor:

MEHQ (p-methoxyphenol produced by Tokyo Chemical Industry)

### Dispersant:

Solsperse 3600 (produced by Lubrizol)

The photocurable color ink compositions used in the Examples and Comparative Examples contain the following constituents.

### Polymerizable Compounds:

Phenoxyethyl acrylate
2-(2-Vinyloxyethoxy)ethyl acrylate

### Photopolymerization Initiator:

Irgacure 819 (acylphosphine oxide-based photoradical polymerization initiator produced by BASF)
Speedcure TPO (acylphosphine oxide-based photoradical polymerization initiator produced Lambson)
Speedcure DETX (thioxanthone-based compound, produced by Lambson)

### Surfactant:

BYK-3500 (polymerization inhibitor, produced by BYK) Polymerization Inhibitor:
MEHQ (p-methoxyphenol produced by Tokyo Chemical Industry)

### Pigment:

Cyan: C.I. Pigment Blue 15
Magenta: Pigment Red 122
Yellow: Pigment Yellow 155
Black: Carbon black

### Dispersant:

Solsperse 3600 (produced by Lubrizol)

### Preparation of Photocurable Clear Ink Composition and Photocurable Color Ink Compositions

A photocurable clear ink composition and photocurable color ink compositions were prepared according to the compositions shown in Table 1 or Table 2.

TABLE 1

| | | Photo- |
|---|---|---|
| | | curable |
| | | clear ink |
| | | composition |
| | | 1 |
| Polymerizable | Phenoxyethyl acrylate | 40.00 |
| compound | 2-(2-Vinyloxyethoxy)ethyl | 40.00 |
| | acrylate | |
| | Dipropylene | 7.20 |
| | glycol diacrylate | |
| Photo- | Irgacure819 | 6.00 |
| polymerization | TPO | 6.00 |
| initiator | | |
| Sensitizer | DETX | 0.50 |
| Surfactant | BYK-3500 | 0.10 |
| Polymerization | MEHQ | 0.20 |
| inhibitor | | |

Values in the table are percentages relative to the total mass of the photocurable clear ink composition.

TABLE 2

| | | Photocurable color ink composition | | | | | | | | | | | | |
|---|---|---|---|---|---|---|---|---|---|---|---|---|---|---|
| | | 1 | 2 | 3 | 4 | 5 | 6 | 7 | 8 | 9 | 10 | 11 | 12 | 13 |
| Polymerizable | Phenoxyethyl acrylate | 43.35 | 43.66 | 41.90 | 42.57 | 41.39 | 41.83 | 42.72 | 43.01 | 42.25 | 41.48 | 37.84 | 39.18 | 40.67 |
| compound | 2-(2- | 45.00 | 45.00 | 45.00 | 45.00 | 45.00 | 45.00 | 45.00 | 45.00 | 45.00 | 45.00 | 45.00 | 45.00 | 45.00 |
| | Vinyloxyethoxy)ethyl | | | | | | | | | | | | | |
| | acrylate | | | | | | | | | | | | | |
| Photopolymerization | Irgacure819 | 5.00 | 5.00 | 5.00 | 5.00 | 5.00 | 5.00 | 5.00 | 5.00 | 5.00 | 5.00 | 5.00 | 5.00 | 5.00 |
| initiator | TPO | 4.00 | 4.00 | 4.00 | 4.00 | 4.00 | 4.00 | 4.00 | 4.00 | 4.00 | 4.00 | 4.00 | 4.00 | 4.00 |
| Sensitizer | DETX | 1.00 | 1.00 | 1.00 | 1.00 | 2.00 | 2.00 | 2.00 | 2.00 | 2.00 | 1.00 | 1.00 | 2.00 | 2.00 |
| Surfactant | BYK-3500 | 0.20 | 0.20 | 0.20 | 0.20 | 0.20 | 0.20 | 0.20 | 0.20 | 0.20 | 0.20 | 0.20 | 0.20 | 0.20 |
| Polymerization | MEHQ | 0.20 | 0.20 | 0.20 | 0.20 | 0.20 | 0.20 | 0.20 | 0.20 | 0.20 | 0.20 | 0.20 | 0.20 | 0.20 |
| inhibitor | | | | | | | | | | | | | | |
| Pigment | Cyan PB15 | 0.96 | 0.72 | — | — | — | — | — | — | — | 2.40 | — | — | — |
| | Magenta PR122 | — | — | 2.08 | 1.56 | — | — | — | — | 1.04 | — | 5.20 | — | — |
| | Yellow PY155 | — | — | — | — | 1.70 | 1.36 | — | — | — | — | — | 3.40 | — |
| | Black Carbon black | — | — | — | — | — | — | 0.68 | 0.45 | — | — | — | — | 2.25 |
| Dispersant | Sol36000 | 0.29 | 0.22 | 0.62 | 0.47 | 0.51 | 0.41 | 0.20 | 0.14 | 0.31 | 0.72 | 1.56 | 1.02 | 0.68 |

Values in the table are percentages relative to the total mass of the photocurable color ink composition.

### Examples 1 to 9, Comparative Examples 1 to 4

Rectangular solid three-dimensional objects were produced by using combinations of the photocurable clear ink composition and a photocurable color ink composition shown in Table 3. More specifically, an additive manufacturing apparatus (manufactured by Seiko Epson) was charged with the photocurable clear ink composition and any of the photocurable color ink compositions, and the ink compositions were each applied onto a desired portion of an underlying member (light-shield layer) by a piezoelectric ink jet method so that the color dot incidence would be less than 100% (application). At this time, the photocurable clear ink composition was applied onto the portion not subjected to the application of the photocurable color ink composition so that the cured layer described below could have a constant height. Next, the photocurable clear ink composition and the photocurable color ink composition were cured by irradiating the underlying member onto which the ink compositions were applied with UV radiation, thus forming a 10 μm-thick cured layer (curing). The steps of application and curing were repeated and, thus, a three-dimensional object including 10 cured layers (hereinafter referred to as a 10-layer object). The graininess of the three-dimensional object was evaluated as described herein later. The underlying member for the second or higher order layer is the cured layer immediately under the second or higher order layer. In these steps, the dot arrangement for the 10 cured layers was varied among the cured layers by the above-described dither mask shift control.

Also, three-dimensional objects defined by a single cured layer (herein after referred to as single-layer objects) were produced in the same manner except for using only a photocurable color ink composition without using the photocurable clear ink composition. The resulting single-layer objects were each used for measuring the absorbance of the pigment, the OD, and the UV curability of the corresponding photocurable color ink composition.

TABLE 3

| | Example 1 | Example 2 | Example 3 | Example 4 | Example 5 | Example 6 | Example 7 |
|---|---|---|---|---|---|---|---|
| Photocurable clear ink | 1 | 1 | 1 | 1 | 1 | 1 | 1 |
| composition | | | | | | | |
| Photocurable color ink | 1 | 2 | 3 | 4 | 5 | 6 | 7 |
| composition | | | | | | | |
| Pigment absorbance | 0.54 | 0.41 | 0.58 | 0.43 | 0.83 | 0.66 | 0.34 |
| (thickness: 10 μm) | | | | | | | |
| OD (thickness: 10 μm) | 0.89 | 0.67 | 0.74 | 0.56 | 0.91 | 0.73 | 0.61 |
| | A | A | A | A | A | A | A |
| OD (thickness: 100 μm) | 2.30 | 2.30 | 2.30 | 2.30 | 1.83 | 1.83 | 2.20 |
| | A | A | A | A | A | A | A |
| Granularity | A | A | A | A | A | A | A |
| UV curability | A | A | A | A | A | A | A |

| | | | Comparative | Comparative | Comparative | Comparative |
|---|---|---|---|---|---|---|
| | Example 8 | Example 9 | Example 1 | Example 2 | Example 3 | Example 4 |
| Photocurable clear ink | 1 | 1 | 1 | 1 | 1 | 1 |
| composition | | | | | | |
| Photocurable color ink | 8 | 9 | 10 | 11 | 12 | 13 |
| composition | | | | | | |
| Pigment absorbance | 0.23 | 0.14 | 1.35 | 1.44 | 1.65 | 1.14 |
| (thickness: 10 μm) | | | | | | |
| OD (thickness: 10 μm) | 0.40 | 0.37 | 2.23 | 1.85 | 1.82 | 2.02 |
| | A | A | B | B | B | B |
| OD (thickness: 100 μm) | 2.20 | 2.25 | 2.33 | 2.33 | 1.83 | 2.20 |
| | A | A | A | A | A | A |
| Granularity | A | A | C | C | B | C |
| UV curability | A | A | A | A | B | B |

The properties of the resulting three-dimensional objects were evaluated as described below.

### Absorbance the Pigment

The absorbance of the single-layer object of 10 μm in thickness was measured with a spectrophotometer. The measurement wavelength for the layer using the cyan (Cy) pigment was 615 nm; the measurement wavelength for the layer using the magenta (M) pigment was 561 nm; the measurement wavelength for the layer using the yellow (Y) pigment was 410 nm; and the measurement wavelength for the layer using the black (K) pigment was 500 nm.

### Optical Density (OD)

The single-layer object of 10 μm in thickness and the 10-layer object of 100 μm in thickness were each subjected to measurement of OD (reflective optical density) value with SPECTROLINO (manufactured by Gretag Macbeth) at a viewing angle of 2 degrees with a D50 light source and no filter, and the results were evaluated according to the following criteria. When a 10-layer object is rated as A in the following measurements, the color development of the object is determined to be good.

OD (10 μm-thick object)

A: OD was less than 1.0.

B: OD was 1.0 or more.

OD (100 μm-thick object using any one of pigments Cy, M, or K)

A: OD was 2.1 or more.

B: OD was less than 2.1.

OD (100 μm-thick object using Y pigment)

A: OD was 1.7 or more.

B: OD was less than 1.7.

### Graininess

A layer of the 10-layer object, having a color ink dot incidence of less than 20% was visually observed. The layers of the Examples and Comparative Examples used for evaluating graininess by visual observation had the same OD value as each other.

A: The layer was not grainy at all.

B: Marked graininess was slightly observed.

C: Graininess was marked.

### UV Curability

UV curability of the photocurable color ink compositions when the single-layer object was formed at a duty of 100% was examined.

A: Irradiation energy was less than 200 mJ/cm².

B: Irradiation energy was 200 mJ/cm² or more.

As is clear from the results of the Examples and Comparative Examples, the use of a photocurable color ink composition containing a coloring material with a content in a specific range enables graininess to be reduced when pale colors are expressed by controlling the thickness of cured layers, and enables deep colors to be satisfactorily developed when the deep color is expressed by controlling the number of cured layers to be stacked. In addition, such a photocurable ink composition exhibited good UV curability.

What is claimed is:

1. A method for producing a three-dimensional object by stacking cured layers of a photocurable color ink composition containing a coloring material, the method comprising:
applying the photocurable color ink composition onto an underlying member; and
curing the photocurable color ink composition with light,
wherein the content of the coloring material in the photocurable color ink composition is in the range of 0.25% by mass to 2.1% by mass.

2. A method for producing a three-dimensional object by stacking cured layers formed of a photocurable color ink composition containing a coloring material and a photocurable clear ink composition containing no coloring material, the method comprising:
applying the photocurable color ink composition and the photocurable clear ink composition onto an underlying member, and
curing the photocurable ink compositions with light,
wherein the content of the coloring material in the photocurable color ink composition is in the range of 0.25% by mass to 2.1% by mass.

3. The method according to claim 1, wherein the cured layers each have a thickness in the range of 4 μm to 15 μm.

4. The method according to claim 2, wherein the cured layers each have a thickness in the range of 4 μm to 15 μm.

5. The method according to claim 1, wherein a 10 μm-thick photo-cured film formed by curing the photocurable color ink composition with light has an optical density in the range of 0.30 to 1.00.

6. The method according to claim 2, wherein a 10 μm-thick photo-cured film formed by curing the photocurable color ink composition with light has an optical density in the range of 0.30 to 1.00.

7. The method according to claim 1, wherein a 100 μm-thick cured film formed by curing the photocurable color ink composition with light has an optical density in the range of 1.80 to 2.30.

8. The method according to claim 2, wherein a 100 μm-thick cured film formed by curing the photocurable color ink composition with light has an optical density in the range of 1.80 to 2.30.

9. The method according to claim 1, wherein the applying includes: obtaining a formative data set for each cured layer of the three-dimensional object; generating ink ejection data for each cured layer by using the corresponding formative data set, the ink ejection data being used for ejecting the photocurable color ink composition for the corresponding cured layer; and ejecting the photocurable color ink composition layer by layer,
wherein the ink ejection data are generated by dithering for a halftoning operation of the formative data set, and wherein when the halftoning operation is executed for each of the cured layers to be stacked, a dither mask is applied in different manners to the same position of the cured layers to which the photocurable color ink composition is deposited.

10. The method according to claim 2, wherein the applying includes: obtaining a formative data set for each cured layer of the three-dimensional object; generating ink ejection data for each cured layer by using the corresponding formative data set, the ink ejection data being used for ejecting the photocurable color ink composition for the corresponding cured layer; and ejecting the photocurable color ink composition layer by layer,
wherein the ink ejection data are generated by dithering for a halftoning operation of the formative data set, and wherein when the halftoning operation is executed for each of the cured layers to be stacked, a dither mask is applied in different manners to the same position of the cured layers to which the photocurable color ink composition is deposited.

11. An ink set used in a method for producing a three-dimensional object, the ink set comprising:
a photocurable color ink composition containing a coloring material; and
a photocurable clear ink composition containing no coloring material,
wherein the content of the coloring material in the photocurable color ink composition is in the range of 0.25% by mass to 2.1% by mass.

12. An apparatus adapted to produce a three-dimensional object by stacking cured layers of a photocurable color ink composition containing a coloring material,
wherein the content of the coloring material in the photocurable color ink composition is in the range of 0.25% by mass to 2.1% by mass.
